(19) United States
(12) Patent Application Publication
(10) Pub. No.: US 2005/0284211 A1
(43) Pub. Date: Dec. 29, 2005

(54) Method for detection of leaks

(76) Inventors: John O. Cram, Hilton Head Island, SC (US); Miguel Castillo, Hilton Head Island, SC (US)

Correspondence Address: WILLIAM H. EILBERG, THREE BALA PLAZA, SUITE 501 WEST, BALA CYNWYD, PA, 19004, US

(21) Appl. No.: 11/158,637

(22) Filed: Jun. 21, 2005

Related U.S. Application Data
(60) Provisional application No. 60/582,208, filed on Jun. 23, 2004.

(51) Int. Cl. G01M 3/04

(52) U.S. Cl. 73/40

(57) ABSTRACT

A method of detecting gas leaks includes applying a foam to a surface to be tested, and watching for bubbles, or other movement, in the foam. The foam is formed of a liquid having air dispersed in the liquid. The bubbles formed in the presence of a leak are visible to the naked eye, and are different from the tiny bubbles which define the original foam. The foam adheres readily to the surface, and does not run off or drip. Moreover, a relatively small quantity of liquid is needed, because the foam includes mostly air. The method is thus more economical, and more reliable, than leak detecting methods of the prior art.

### BACKGROUND OF THE INVENTION

The present invention relates to the detection of gas leaks in pipes, joints, valves, seals, and the like, and provides a method which includes depositing a leak detecting material onto a surface, so as to provide a visual indication of the location of a leak.

Leak detection is important in many contexts. Leakage of gases from pipes causes unnecessary waste and expense. Leakage of refrigerants, from fluid lines or components in air conditioning or refrigeration systems, degrades the performance of the unit, and may even render the unit unusable. In some cases, leaks can be dangerous, when they involve the escape of harmful substances into the environment. Leaks of flammable materials present obvious hazards. For these reasons, considerable efforts have been made, in the prior art, to provide reliable methods for ascertaining the site of a leak, so that the leak can be promptly repaired.

It has been known, in the prior art, to use certain liquid preparations for the detection of leaks. These liquid preparations may comprise soaps, detergents, wax emulsions, and the like, usually in a thickened form, and often specially formulated for use in leak detection. The liquid is applied to a surface or joint being tested, either with a “dabber” or by spraying with a trigger sprayer. When a leak is present, gas or air escaping from the surface or joint encounters the deposited liquid, and forms a bubble. In theory, even a very tiny leak will likely form a bubble, so the process converts an imperceptible leak into one which can be located visually, simply by observing where the bubbles appear.

Leak detecting compositions are made so as to optimize the above-described process. Thus, the materials may be formulated such that the bubble is relatively long-lasting, so that it will be noticed before it bursts. Some leak detecting materials are designed to be used in below freezing temperatures. Still other materials have particular colors that make the materials more appropriate for use in specific applications. And of course, the ideal composition is one that will not harm the surfaces to which it is applied, and will not react with the material that is leaking.

A liquid leak-detecting material has the disadvantage that it is likely to run off as it is being applied. Moreover, depending on the orientation of the surface to which the liquid is applied, some of the liquid is likely to drip off. Not only does run-off and dripping cause waste of the liquid, but the run-off and/or dripping means that the liquid unintentionally comes into contact with some other surface, possibly causing contamination. The unwanted flow of liquid may also have some harmful effect on metal or plastic surfaces in the environment of the area being tested. Moreover, when the test is completed, the liquid usually must be wiped off and removed.

The present invention provides a method and material which improves the above-described process of leak detection. The method of the present invention overcomes the problems associated with the use of liquids for leak detection, and provides a method that is both reliable and economical.

### SUMMARY OF THE INVENTION

The present invention comprises applying a layer of foam to a surface, and monitoring that surface for changes in the foam, such changes being indicative of a leak. The changes observed are the formation of bubbles in the foam, and/or movement of the foam layer. The bubbles indicating a leak are visible to the naked eye, and are different from the tiny bubbles that define the original foam.

The foam is made of a liquid, such as soap, detergent, wetting agent, or other material, in which a gas such as air is dispersed. When the foam has been formed, it can be applied to virtually any kind of surface, such as that of a pipe, a valve, a pump, a container, or any other component that holds or transfers gases under pressure. When applied, the foam readily adheres to the surface, retains its shape, and tends not to run off or drip. Preferably, the foam is applied to the surface in a layer which may be up to about 0.25 inches thick.

The method of the present invention is economical because the leak detecting material is not wasted through run-off or dripping, and because a relatively small amount of material is needed to make the foam, the foam comprising mainly air. Also, the invention reduces or eliminates the problem caused by unwanted interaction between the leak detecting material and surfaces or materials in the vicinity of the surface being tested.

The present invention therefore has the primary object of providing a method of detecting leaks.

The invention has the further object of improving the reliability and efficiency of a leak detection process.

The invention has the further object of providing a leak detection method which is unlikely to contaminate surfaces in the vicinity of the surface being tested.

The invention has the further object of providing a leak detection method which is sufficiently sensitive to enable visual detection of tiny leaks that are not visible to the naked eye.

The invention has the further object of reducing the cost of leak detection.

The reader skilled in the art will recognize other objects and advantages of the present invention, from a reading of the following detailed description of the invention, and the appended claims.

### DETAILED DESCRIPTION OF THE INVENTION

The present invention comprises applying a foam to a surface or joint, for the purpose of revealing a gas leak. It has been discovered that even a tiny leak will cause the foam to generate bubbles that are larger than the bubbles which initially define the foam, so as to expose the location of the leak.

A foam, by definition, is a dispersion of gas, such as air, in a liquid or solid. The foam used in the present invention comprises a liquid in which gas, usually air, is dispersed. In particular, the foam used in the present invention includes a relatively small amount of liquid in which there are dispersed a large number of very small air bubbles. These bubbles can have a wide range of sizes, from colloidal to macroscopic, as in soap bubbles. The foam can be formed from a detergent, a soap, a wetting agent, or other material. When the foam is applied to a surface, and when there is a leak in the region immediately adjacent to the deposited foam, a “froth”, or a larger bubble, shows immediately, accurately indicating the location of the leak. While the bubbles initially defining the foam may or may not be visible to the naked eye, the bubbles which indicate a leak are always clearly-visible.

Typically, the thickness of the foam applied to the surface may be about 0.25 inches, although the invention should not be deemed limited by the thickness of the applied foam, and there may be cases in which a thicker layer is desirable. When a leak is detected, the froth causes the foam to appear to rise up, as the bubbles created or stimulated by the leak penetrate the foam layer.

In general, the bubbles that are visible to the naked eye, upon detection of a leak by the present invention, are different from the bubbles that make up the original foam, the latter bubbles usually being microscopic and not plainly visible.

A significant advantage of the use of foam is that the foam generally adheres readily to the surface to which it is applied, and does not run off or drip, as is true for liquids. Thus, it is practical to apply the foam selectively to one or more desired sites, including surfaces that have a non-horizontal orientation, without wasting leak detecting material. In the prior art, it is common to waste much of the leak detecting material, because of the tendency for liquid to run off and/or drip instead of remaining adhered to the surface of interest.

The foam used in the present invention leaves a relatively long-lasting spot, which can indicate the location of the leak even after the activity of the foam is exhausted. The foam dries on the surface to which it is applied, and can be removed without leaving a residue.

The foam used in the present invention can be made from any bubble-producing or foam-producing material, provided in a concentration that is practical for the making of foam. It is possible to use an existing, prior art spray device for forming the foam from a liquid. Spray devices used in dispensing hand soaps, shampoos, shaving creams, etc. could be used to make the foam used in the invention. The invention is not limited by the method of making the foam, or by the equipment used to make the foam.

The leak detection method of the present invention can be used on virtually all types of pipes, valves, pumps, fluid lines, refrigeration lines, joints, containers, and related parts, that hold or transfer gases under pressure. These gases could include not only air, but also such gases as propane, hydrogen, nitrogen, oxygen, natural gas, or refrigerants, or any combination thereof.

The foam used in the present invention can be produced from any liquid soap, detergent, or wetting agent that is designed to produce a foam when aerated or wetted under pressure. The foam product can vary in formulation depending on its intended use. For example, the product can be formulated with regard to how the product will react with the leaking material, or how it will react with metal or plastic surfaces to which it is applied. The product may also be specially designed to work above or below freezing temperatures.

The material used to make the foam must preferably produce bubbles that are relatively stable, lasting long enough to be noticed visually within a reasonable allotted time.

The present invention was tested with a small laboratory device which simulated leakage in the field, by directing air, under various amounts of pressure, through small holes. The device thus enabled an operator to simulate a small and almost invisible leak, as well as larger leaks involving larger flow rates of air. A foaming device, used in the cosmetic field to provide a hand soap or shaving cream, was used to produce a foam which was applied to the test surface. The result was an additional foam, produced in what was already a microfoam, the additional foam being very quickly and easily observed.

The present invention is capable of detecting virtually any size leak, even those which are not visible to the naked eye. Even the smallest stream of air or other gas, seeping out of an opening, will suffice to create visible bubbles in the foam.

Not only is the present invention an improvement with regard to the ease of detecting a small leak, but it is also more economical than prior art methods. By using a foam instead of a liquid, the problem of run-off or dripping is substantially eliminated, thus reducing waste of material. The foam adheres to the surface to which it applies, while retaining its shape. Moreover, since the amount of liquid used to form the foam is relatively small, as the foam comprises mostly air, only a small quantity of leak detecting material is required, thereby achieving further economy as compared with the prior art.

The foam of the present invention also leaves little or no residue, and is unlikely to contaminate nearby surfaces.

The present invention is not limited by the type of surface being tested for leaks. Also, the foam used in the present invention can be modified, as explained above. These and other modifications of the invention should be considered within the spirit and scope of the following claims.

1. A method of detecting a gas leak, comprising applying a foam to a surface being tested, and observing the surface to monitor changes in the foam, so as to determine the presence of a leak.

2. The method of claim 1, wherein the foam is made from a material selected from the group consisting of soaps, detergents, and wetting agents.

3. The method of claim 1, wherein the foam comprises air dispersed in a liquid.

4. The method of claim 1, wherein the foam is applied to the surface in a layer, and wherein the observing step comprises observing the surface for movement or visible bubbles in the layer of foam.

5. The method of claim 4, wherein said layer has a thickness of about 0.25 inches.

6. The method of claim 1, wherein the applying step comprises applying the foam to a portion of the surface which is non-horizontal, wherein the foam remains adhered to the surface.

7. In a leak detection process, wherein a leak detecting material is applied to a surface which is to be tested for leakage of gas, the improvement comprising selecting the leak detecting material to be a foam.

8. The improvement of claim 7, wherein the foam is selected to comprise a liquid having air dispersed therein.

9. The improvement of claim 7, further comprising visually observing the surface for signs of bubbling.

10. The improvement of claim 7, further comprising visually observing the surface for signs of movement of the foam.

11. The improvement of claim 7, further comprising the step of making the foam by aerating a material selected from the group consisting of liquid soaps, detergents, and wetting agents.

12. A method of detecting a leak in a substrate, the method comprising the steps of depositing a foam on at least a portion of the substrate, the foam including a plurality of small bubbles, and observing the foam on the substrate to monitor changes in the foam, and determining existence of a leak upon observation of bubbles in the foam larger than the small bubbles defining the foam.

13. The method of claim 12, wherein the depositing step comprising depositing the foam in a layer having a thickness of at least about 0.25 inches.

14. The method of claim 12, further comprising the step of making the foam by aerating a material selected from the group consisting of liquid soaps, detergents, and wetting agents.

15. The method of claim 12, wherein the depositing step comprises applying the foam to a portion of the substrate which is non-horizontal, wherein the foam remains adhered to the substrate.
